(19) United States
(12) Patent Application Publication
(10) Pub. No.: US 2003/0129489 A1
(43) Pub. Date: Jul. 10, 2003

(54) Energy device having collectors with rubber materials stacked in layers and a method of fabricating the energy device

(75) Inventors: Hiroyuki Kamisuki, Sendai-shi (JP); Toshihiko Nishiyama, Sendai-shi (JP); Gaku Harada, Tokyo (JP); Shinako Kaneko, Sendai-shi (JP); Masato Kurosaki, Tokyo (JP); Yuji Nakagawa, Tokyo (JP); Tomoki Nobuta, Sendai-shi (JP); Masaya Mitani, Sendai-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: NEC Tokin Corporation, Sendai-shi (JP)

(21) Appl. No.: 10/331,019

(22) Filed: Dec. 27, 2002

(30) Foreign Application Priority Data
Dec. 28, 2001 (JP) 399885/2001

(51) Int. Cl. H01M 2/08; H01M 10/04

(52) U.S. Cl. 429/185; 429/162; 29/623.2; 29/623.4

(57) ABSTRACT

In a basic cell of an energy device, a pair of electrodes are disposed opposite to each other via a separator interposed therebetween. A pair of collectors are disposed to be in contact with the outer surfaces of the electrodes. A gasket is cooperated with the collectors to surround the separator and the electrodes. An electrolyte is filled in a region surrounded by the collectors and the gasket. Each of the collectors has a first and a second rubber material stacked in layers. By connecting in series a plurality of basic cells each having the foregoing structure, a desired energy device can be obtained.

This application claims priority to prior application JP2001-399885, the disclosure of which is incorporated herein by reference.

### BACKGROUND OF THE INVENTION

The present invention relates to an energy device such as an electric double layer capacitor, electrochemical capacitor or secondary battery and a fabricating method therefor and, more specifically, relates to an energy device configured to contain an electrolyte in a basic cell and a fabricating method therefor.

In recent years, there have been many uses of heavy currents in various fields ranging from electronic devices having backup functions over to automotive vehicles, mainly electric vehicles, so that the development of corresponding energy devices has been carried out extensively. Presently, an electric double layer capacitor disclosed in JP-A-2001-76971, a polymer secondary battery proposed in JP-A-H11-126610 which utilizes electron exchange following oxidation-reduction reactions of an active material using proton as a medium, and so forth have been developed as effective devices for the foregoing uses.

The electric double layer capacitor, electrochemical capacitor and secondary battery each have a basic cell of a like structure. FIG. 1 is a sectional view showing a structure of the basic cell.

In FIG. 1, as electrodes 1, solid activated carbon such as an activated carbon/polyacene material is used in case of an electric double layer capacitor, while a conductive high polymer such as polyaniline is used in case of a polymer secondary battery, for example. A pair of electrodes 1 serve as positive and negative electrodes and are disposed so as to confront each other via an electron-nonconductive ion-permeable separator 2 interposed therebetween. An electrolyte is sealed in a region encircled by an insulating frame-like gasket 3 and a pair of electroconductive collectors 4. Each collector 4 is formed by, for example, a single rubber or plastic layer containing conductive carbon, and attached to the corresponding electrode 1. An assembly of the electrodes 1, the separator 2, the gasket 3, the collectors 4 and the electrolyte constitutes the basic cell, and terminal boards 5 are disposed on both outer sides of the assembly.

When the foregoing energy device is used for the purpose requiring a heavy current, it is necessary to reduce ESR (Equivalent Series of Resistance) particularly for suppressing a voltage drop upon use thereof. For reducing ESR, a method can be considered that increases the compounding amount of the conductive material in the rubber material forming the collector, thereby to reduce a resistivity value of the collector.

As described above, for giving the conductivity to the collector, the rubber material obtained by compounding the conductive material such as conductive particles or conductive fibers with the base material is used. Depending on the kind of base material, the compoundable amount of the conductive material in the base material differs. In general, as the compounding ratio of a conductive material relative to a base material is increased, the resistivity is reduced, while there is a tendency that the gas barrier performance is lowered.

Further, the gas barrier performance largely depends on a base material that is used in a rubber material. When a rubber material with low resistivity is used, the gas barrier performance is low so that the prescribed gas barrier performance can not be satisfied. In view of this, as the base material of the collector, butyl rubber (IIR) with a thickness of approximately 200 μm that is excellent in gas barrier performance has been used. However, inasmuch as the resistivity of IIR is not sufficiently small, IIR can not satisfy the demand for further reducing ESR.

The resistivity of the rubber material can be lowered by reducing a thickness thereof. However, if the thickness of the rubber material is reduced, the film strength is lowered and there is a tendency that the gas barrier performance is also lowered. Following the lowering of the gas barrier performance, drying up of an electrolyte tends to occur, so that there has been raised a problem of lowering of the capacity and increase of ESR. Accordingly, it has been difficult to simultaneously satisfy smaller ESR and excellent gas barrier performance using a collector made of the sole rubber material having a thickness that can exhibit a sufficient film strength. Further, much labor is required to newly develop a rubber material that can simultaneously satisfy a low resistance and high gas barrier performance with a film thickness that can exhibit a sufficient film strength.

Hitherto, as a means for reducing ESR, there has been known a method in which an electrode and a collector are joined together by a conductive bonding agent. For example, JP-A-H3-283518 proposes an electric double layer capacitor wherein a conductive bonding agent is applied over a collector and an electrode adheres to the collector by heat press. JP-A-H1-340093 proposes an electric double layer capacitor wherein an expanded graphite layer is formed on both sides or one side of a conductive rubber sheet thereby to reduce a contact resistance relative to an electrode. JP-A-2001-76971 proposes an electric double layer capacitor wherein a collector is formed with a conductive coating film on the surface of silver foil so that a contact resistance relative to an electrode is small.

However, in the electric double layer capacitor described in JP-A-H11-340093 or JP-A-2001-76971, although the contact resistance can be lowered, a resistance of the bonding agent itself or a resistance of the collector itself can not be ignored, and thus no large effects can be observed with respect to lowering of ESR of the whole battery cell. In the electric double layer capacitor described in JP-A-2001-76971, when an acid or metal corrosive liquid is used as an electrolyte, it is considered that the liquid corrodes the silver foil via the conductive coating film. If the thickness of the conductive coating film is increased for preventing it, the resistance of the conductive coating film itself is increased to resultantly increase ESR of the battery cell, and thus not sufficient as the ESR lowering means.

JP-A-H11-340093 and JP-A-2001-76971 aim to reduce ESR by reducing the contact resistance between the electrode and the collector, while JP-A-2001-76971 aims to reduce ESR by forming the collector into a laminate structure of the silver foil and the conductive coating film, and thus neither of them reduces the resistance of the collector itself.

Further, in a fabricating method for each of the foregoing electric double layer capacitors, a process for applying the conductive bonding agent, the conductive auxiliary layer or the conductive coating film is required so that the whole fabricating process is prolonged, and in addition, a quality control of the conductive material, a thickness control of the coating film, or the like is further required.

### SUMMARY OF THE INVENTION

It is therefore an object of the present invention to provide a thin-type energy device with small ESR that can suppress drying up of an electrolyte to a low level.

It is another object of the present invention to provide a simple fabricating method for the foregoing energy device.

Other objects of the present invention will become clear as the description proceeds.

According to one aspect of the present invention, there is provided an energy device comprising a separator, a pair of electrodes disposed opposite to each other via the separator, a pair of collectors disposed so as to be in contact with outer surfaces of the electrodes, respectively, a gasket cooperated with the collectors to surround the separator and the electrodes and an electrolyte filled in a region surrounded by the collectors and the gasket, each of the collectors having a first and a second rubber material stacked in layers.

According to another aspect of the present invention, there is provided a method of fabricating an energy device comprising the steps of sandwiching a separator between a pair of electrodes in a stacked manner to form a first assembly, placing the first assembly within a gasket having a vulcanization adhesive property, superposing a plurality of rubber materials to each other to form a pair of collectors, each of the rubber materials having each vulcanization adhesive properties, sandwiching the first assembly between the collectors in a stacked manner to form a second assembly, pressurizing the second assembly from both sides in a stacking direction thereof, and heating the second assembly to unify the second assembly.

### BRIEF DESCRIPTION OF THE DRAWINGS

FIG. 1 is a sectional view showing a structure of a basic cell in related art;

FIG. 2 is a sectional view showing a structure of a basic cell of an energy device according to a preferred embodiment of the present invention; and

FIG. 3 is a diagram showing a correlation between a film thickness of a rubber material that is usable for a collector included in the basic cell and an electrolyte reduction rate.

### DESCRIPTION OF THE PREFERRED EMBODIMENTS

Referring to FIG. 2, a structure of a basic cell of an energy device according to a preferred embodiment of the present invention will be described.

In the basic cell of FIG. 2, electrodes 1 serving as positive and negative electrodes are disposed opposite to each other via a separator 2 impregnated with an electrolyte. Collectors 4 are disposed to be in contact with the outer surfaces of the electrodes 1, respectively. A gasket 3, cooperatively with the collectors 4, encircles the separator 2 and the electrodes 1 and seals therein an electrolyte. Each of the collectors 4 has first and second rubber materials 4A and 4B having different compositions and stacked in layers to form a first and a second layer. On the outer surfaces of the collectors 4, metal terminal boards 5 are disposed. The terminal boards 5 are provided for energization. A plurality of basic cells each having the foregoing structure are connected in series at need, thereby to obtain a desired energy device such as an electric double layer capacitor, an electrochemical capacitor or a secondary battery.

In case of an electric double layer capacitor, for example, each electrode 1 is obtained by solidifying powdered activated carbon or fibrous activated carbon as an active material with a binder of tetrafluoroethylene resin and dispersing it in a binder of polyvinylidene fluoride or the like, or by mixing such activated carbon with a binder of phenol resin at need and, after molding, dispersing a sintered body heat-treated in an inert atmosphere, in a binder of polyvinylidene fluoride or the like.

In case of a polymer secondary battery, each electrode 1 is obtained by dispersing in a binder of polyvinylidene fluoride or the like, a conductive high polymer as an active material such as a Tr conjugated high polymer like polyaniline, polythiophene, polypyrrole, polyacetylene, poly-p-phenylene, polyphenylenevinylene, polyperinaphthalene, polyfuran, polyflurane, polythienylene, polypyridinediyl, polyisothianaphthene, polyquinoxaline, polypyridine, polypyrimidine, polyindole, polyaminoanthraquinone, or a derivative thereof, or a high polymer containing a hydroxyl group (quinone oxygen becomes a hydroxyl group by conjugation) like polyanthraquinone or polybenzoquinone, and a conductive auxiliary agent like carbon black. In this case, a redox pair is formed by applying doping to the conductive high polymer at need, so that conductivity is manifested. Doping is carried out according to either a method in which an electrolyte solution containing anions as dopants is added to powder of material polymers and heating is suitably applied thereto to implement doping electrochemically or chemically, or a method in which the polymers are formed into a shape of an electrode along with a conductive auxiliary agent and binder resin, then doping is applied thereto in the same manner. When applying the polymers to positive and negative electrodes, suitable polymers are selected and combined based on differences in oxidation-reduction potential.

There is no particular limitation to the separator 2 inasmuch as it is electron-nonconductive and ion-permeable. Specifically, as the separator 2, an olefin porous film or an ion exchange resin film can be used.

As the electrolyte, a metal corrosive or acid electrolyte can be used. As an electrolyte solution for obtaining the electrolyte, an aqueous electrolyte solution such as sulfuric acid or potassium hydroxide, or an electrolyte solution obtained by dissolving quaternary ammonium salt, quaternary phosphonium salt or the like into an organic solvent such as propylene carbonate, can be used, for example.

Each of the rubber materials 4A and 4B is obtained by mixing a given amount of a conductive material or conductive member such as conductive particles or conductive fibers into a base material such as rubber or resin. The base material is sufficient inasmuch as it has a resistance against the electrolyte, and thus may be, for example, butyl rubber (IIR), styrene rubber (SBR), nitrile rubber (NBR), ethylene propylen dien rubber (EPDM), fluoro rubber (FPM), chlorosulfonated polyethylene (CSM), butadiene rubber (BR) or silicone rubber (SI). As the conductive material, powder or fibers of metal and carbon are used. However, in case of using an acid solution as an electrolyte, a given amount of industrial carbon black is added.

As means for reducing ESR based on the structure of the collector, there can be considered two methods, i.e. (1) lowering the resistivity of the collector, and (2) reducing the film thickness of the collector. In case of the former, it is necessary to increase the ratio of the conductive material in the rubber material. However, since the addable amount of the conductive material changes depending on the rubber material, the resistivity range differs depending on the rubber material and, following it, the gas barrier performance also differs. For example, in case of EPDM, the conductive material can be compounded much, and thus the resistivity can be lowered. However, as the compounding amount of the conductive material increases, the gas barrier performance is deteriorated. On the other hand, in case of the latter wherein the film thickness is simply reduced, when the film strength is lowered to the film thickness being less than 120 μm, a crack is generated in the collector film due to a difference in expansion/contraction relative to the electrode element upon vulcanization.

FIG. 3 shows a correlation between a film thickness and an electrolyte reduction rate being an index of the gas barrier performance, with respect to three kinds of rubber materials, i.e. IIR (resistivity: 0.39 Ω·cm), EPDM (resistivity: 0.090 Ω·cm) and NBR (resistivity: 0.080 Ω·cm), as an example. The electrolyte reduction rate was measured in the following manner. First, collectors were vulcanized at 120° C. for an hour to adhere to both surfaces of an IIR gasket having a 4 mm width, thereby to prepare a cell having a content volume of 70 cc (no electrode elements were provided therein). 3 cc of 20% sulfuric acid aqueous solution was filled under pressure from a filler hole of the cell which was then sealed, thereby to obtain an evaluation sample for each rubber material. The evaluation samples were stood in a constant temperature vessel at 60° C. for 500 hours, and the reduction amount of the electrolyte was measured.

From the result of the measurement, it has been found out that there is a tendency that the gas barrier performance is lowered (the electrolyte reduction rate is increased) as the film thickness is reduced, but this tendency differs depending on a material. Therefore, upon reducing ESR, by using a rubber thin film having a low resistivity as a support and combining a rubber thin film having large gas barrier performance, it is possible to hold the film strength and reduce ESR without deteriorating the gas barrier performance.

In the basic cell shown in FIG. 2, a material of which the gas barrier performance is low but the resistivity is small is used as the first rubber material 4A, while a material of which the resistivity is somewhat large but the gas barrier performance is excellent is used as the second rubber material 4B. The first rubber material 4A may include as a base material, for example, ethylene propylen dien rubber (EPDM) or nitrile rubber (NBR) that can be compounded with a lot of conductive particles to realize lowering of the resistance. The second rubber material 4B may include as a base material, for example, the foregoing butyl rubber (IIR), or fluoro rubber (FPM) or the like. Values of the resistivity and gas barrier performance of each rubber material are suitably set depending on the purpose. Each of the collectors 4 has preferably a thickness of 120 μm to 200 μm because it is manufacturable, it can ensure the mechanical strength and it is advantageous in terms of reducing the thickness.

As one example, explanation will be given to a case of using a collector having a two-layered structure composed of a rubber material A having a thickness of tA and a rubber material B having a thickness of tB, so that the collector has a thickness of T (=tA+tB). It is assumed that the resistivity of the rubber material A is smaller than that of the rubber material B and, when the thicknesses thereof are equal to each other, the gas barrier performance of the rubber material A is smaller than that of the rubber material B. When the rubber material A and the rubber material B are stacked in layers, assuming that there is no contact resistance, a resistivity value of the whole collector is given by the sum of a resistivity value of the rubber material A and a resistivity value of the rubber material B. On the other hand, the gas barrier performance of the whole collector is controlled by better one of the gas barrier performance of the rubber material A and the gas barrier performance of the rubber material B. Therefore, the thickness tB of the rubber material B is set so as to satisfy the required gas barrier performance. Unless a resistivity value is less than a required ESR value when the thickness of the rubber material B is tB, ESR of the collector having the rubber material A of the thickness tA stacked thereon can not be equal to or less than the required value. Accordingly, by setting the film thickness tB of the rubber material B to a value that can satisfy both the gas barrier performance and the required ESR value, it is possible to obtain an energy device that suppresses drying up of the electrolyte to a low level and that further reduces ESR.

Theoretically, the thickness of the rubber material B may be set to a value equal to or greater than the minimum film thickness that satisfies the required value of the gas barrier performance. On the other hand, the film thickness tA of the rubber material A is suitably set within a range in which the thickness T of the layered body composed of the rubber material A with the thickness tA and the rubber material B with the thickness tB stacked in layers becomes equal to or greater than a value that can ensure the film strength and equal to or less than a value that can satisfy the required ESR value. Even if each thickness is so small that it can not be used alone due to a shortage of the film strength, the rubber materials A and B with the sufficient film strength can be obtained by stacking them in layers.

FIG. 2 shows the state where in each of the collectors 4, two kinds of rubber materials are stacked in two layers, while three or more layers may be stacked. If the first and second rubber materials 4A and 4B are stacked in three or more layers, it is desirable that the film thickness of the thickest layer of the rubber material 4B forming each collector is set to a value equal to or greater than the minimum film thickness that satisfies the specification of the gas barrier performance. The reason for this is that a linear relationship between a film thickness and gas barrier performance of a rubber material can not be established depending on the kind of rubber material. Incidentally, a linear relationship is established between a film thickness and resistivity irrespective of the kind of rubber material.

Even if a positional relationship between the first rubber material 4A and the second rubber material 4B is reversed from that shown in FIG. 2, there is no change in function as the collector. However, inasmuch as a contact resistance relative to the electrode 1, a contact resistance relative to the terminal board 5 and a bonding strength relative to the gasket 3 change according to a positional relationship between the first and second rubber materials 4A and 4B, it is desirable that the arrangement be actually determined taking it into account. The amounts of the conductive materials contained in the three kinds of base materials shown in FIG. 3 are not uniform. This is because, as described before, the compoundable amount of the conductive material differs depending on the rubber material.

Preferably, the rubber materials 4A and 4B and the gasket 3 have vulcanization adhesive properties. If the fully vulcanized materials are used, vulcanization bonding does not occur between different kinds of materials when an assembly of the collectors 4, the gasket 3 and the electrodes 1 is subjected to thermo-compression bonding, so that the adhesion is poor and thus drying up of the electrolyte tends to occur. Therefore, it is desirable to use such a material that has an unvulcanized portion at least in part thereof. On the other hand, at portions where the gasket 3 and the rubber materials 4A and 4B contact with each other, inasmuch as the vulcanization bonding occurs if a material having a vulcanization adhesive property is used at least in one of them, it is possible to use a material having a vulcanization adhesive property only in one of them.

The energy device having the foregoing basic cell is fabricated according to the following procedure.

First, a separator is sandwiched between a pair of electrodes in a stacked manner to prepare an assembly thereof. The assembly is received in a frame-like gasket having a vulcanization adhesive property. On the other hand, a plurality of rubber materials having vulcanization adhesive properties are stacked to prepare a pair of collectors. The assembly is sandwiched between the collectors in a stacked manner to prepare a composite assembly. The composite assembly is pressurized from both sides in the stacking direction and heated. By heating the composite assembly, the collectors and the gasket are subjected to vulcanization reactions so that the vulcanization bonding occurs between the rubber materials, between the collectors and the gasket, and between the collectors and the electrodes, and thus the composite assembly is unified. In this manner, the energy device having excellent ESR and drying up characteristics can be fabricated according to the extremely simple fabricating processes.

Hereinbelow, various examples and comparative examples will be described.

### (EXAMPLE 1)

Example 1 relates to a polymer secondary battery. PCI (polycyanoindole) was used as an active material of a positive electrode serving as a battery element, while PPQX (polyphenylquinoxaline) was used as an active material of a negative electrode. Approximately 20% of carbon powder serving as a conductive auxiliary material was mixed thereto, respectively, and the mixtures were agitated using a high speed agitator. The powder was subjected to pressure molding at high temperature of 200° C. and uses as electrodes. Then, an olefin porous film was sandwiched between the positive and negative electrodes as a separator to prepare an assembly. The assembly was placed in a gasket made of unvulcanized rubber that was processed to a predetermined size in advance. Then, a conductive film (resistivity: 0.1200 Ω·cm) made of an unvulcanized EPDM rubber material having a thickness of 100 μm and a conductive film (resistivity: 0.3900 Ω·cm) made of an unvulcanized IIR rubber material having a thickness of 100 μm were disposed on each side of the assembly in a stacked manner such that a collector of the EPDM rubber material was disposed on the side of the electrode. Then, the assembly was pressurized under 2 kgf/cm² and stood in a constant temperature vessel at 120° C. for an hour, thereby to prepare a battery cell. Then, a filler hole of a 1.0 mm diameter was opened in the gasket of the cell and an electrolyte was filled into the cell. As the electrolyte, a 40 wt. % sulfuric acid aqueous solution was used. Metal terminal boards were attached to both sides of the battery cell having been subjected to the filling of the electrolyte, and the filler hole was sealed by epoxy resin, thereby to prepare a battery.

ESR values at 1 kHz of 50 batteries thus prepared were measured using a milli-ohm meter, and the mean value thereof was set as an initial ESR value. Further, after measuring initial weight of the batteries, the batteries were stood in a constant temperature vessel at 60° C. for 1000 hours, then weight of the batteries was measured. From the ratio between the weight reduction amount and the filled electrolyte weight, the electrolyte reduction rate was derived for each battery as an alternative characteristic of the gas barrier performance. Further, ESR values after 1000 hours were also measured to derive ESR change rates. The battery whose ESR change rate was 50% or greater was judged to be ESR change abnormal, and the number of such batteries was counted. The result was that the initial ESR value was 18.5 mΩ, the electrolyte reduction rate was 4.2%, and the number of ESR change abnormal batteries was 0.

### (EXAMPLE 2)

Example 2 also relates to a polymer secondary battery. The conductive film (resistivity: 0.120 Ω·cm) made of the unvulcanized EPDM rubber material having the thickness of 100 μm and the conductive film (resistivity: 0.390 Ω·cm) made of the unvulcanized IIR rubber material having the thickness of 100 μm in Example 1 were disposed in a reversed positional relationship, i.e. the collector of the IIR rubber material was disposed on the side of the electrode. The other structure was the same as that in Example 1, and the same evaluation was performed for the produced batteries. The result was that the initial ESR value was 18.5 mΩ, the electrolyte reduction rate was 4.5%, and the number of ESR change abnormal batteries was 0.

### (EXAMPLE 3)

Example 3 also relates to a polymer second battery. A conductive film (resistivity: 0.08 Ω·cm) made of an unvulcanized EPDM rubber material having a thickness of 100 μm and a conductive film (resistivity: 0.390 Ω·cm) made of an unvulcanized IIR rubber material having a thickness of 100 μm were disposed in a stacked manner as collectors such that the collector of the EPDM rubber material was disposed on the side of the electrode. The other structure was the same as that in Example 1, and the same evaluation was performed for the produced batteries. The result was that the initial ESR value was 16.1 mΩ, the electrolyte reduction rate was 7.2%, and the number of ESR change abnormal batteries was 0.

### (EXAMPLE 4)

Example 4 also relates to a polymer second battery. A conductive film (resistivity: 0.120 Ω·cm) made of an unvulcanized EPDM rubber material having a thickness of 50 μm and a conductive film (resistivity: 0.390 Ω·cm) made of an unvulcanized IIR rubber material having a thickness of 100 μm were disposed in a stacked manner as collectors such that the collector of the EPDM rubber material was disposed on the side of the electrode. The other structure was the same as that in Example 1, and the same evaluation was performed for the produced batteries. The result was that the initial ESR value was 16.9 mΩ, the electrolyte reduction rate was 9.0%, and the number of ESR change abnormal batteries was 1.

### (EXAMPLE 5)

Example 5 also relates to a polymer second battery. A conductive film (resistivity: 0.100 Ω·cm) made of an unvulcanized NBR rubber material having a thickness of 100 μm and a conductive film (resistivity: 0.390 Ω·cm) made of an unvulcanized IIR rubber material having a thickness of 100 μm were disposed in a stacked manner as collectors such that the collector of the NBR rubber material was disposed on the side of the electrode. The other structure was the same as that in Example 1, and the same evaluation was performed for the produced batteries. The result was that the initial ESR value was 15.5 mΩ, the electrolyte reduction rate was 6.8%, and the number of ESR change abnormal batteries was 0.

### (EXAMPLE 6)

Example 6 also relates to a polymer second battery. A conductive film (resistivity: 0.390 Ω·cm) made of an IIR rubber material of a 30% vulcanization degree having a thickness of 80 ρm was sandwiched between two conductive films each (resistivity: 0.120 Ω·cm) made of an EPDM rubber material of a 50% vulcanization degree having a thickness of 60 μm so that the films were stacked in three layers as collectors. The other structure was the same as that in Example 1, and the same evaluation was performed for the produced batteries. In this example, since the thin films with low strength were used, the vulcanization degree was somewhat increased for each film. The result was that the initial ESR value was 15.0 mΩ, the electrolyte reduction rate was 6.5%, and the number of ESR change abnormal batteries was 0.

### (EXAMPLE 7)

Example 7 relates to an electric double layer capacitor. Activated carbon was used for electrodes, and a conductive film (resistivity: 0.120 Ω·cm) made of an unvulcanized EPDM rubber material having a thickness of 80 μm and a conductive film (resistivity: 0.390 Ω·cm) made of an unvulcanized IIR rubber material having a thickness of 80 μm were disposed in a stacked manner as collectors such that the collector of the EPDM rubber material was disposed on the side of the electrode. The other structure of the electric double layer capacitor was the same as that in Example 1, and the same evaluation was performed for the produced batteries. The result was that the initial ESR value was 6.5 mΩ, the electrolyte reduction rate was 5.5%, and the number of ESR change abnormal batteries was 0.

### (COMPARATIVE EXAMPLE 1)

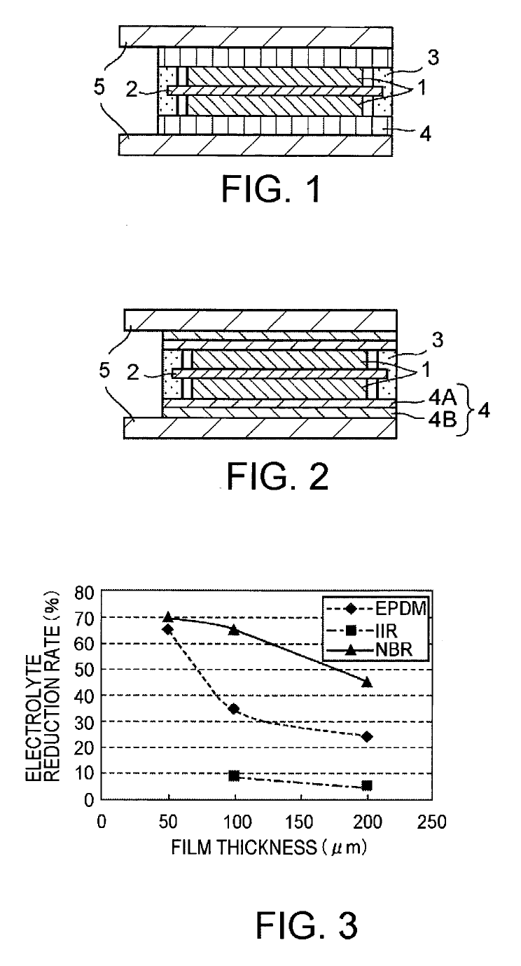

Comparative Example 1 relates to a polymer secondary battery. In the basic cell shown in FIG. 1, the battery elements composed of the electrodes 1 and the separator 2, and the electrolyte were hermetically enclosed by the gasket 3 and the monolayer collectors 4. The terminal boards 5 were disposed on the outer sides of the collectors for performing energization. As each collector, a conductive film (resistivity: 0.390 Ω·cm) made of an unvulcanized IIR rubber material having a thickness of 200 μm was used. Other than the conductive film made of one kind of rubber material was used as the collector, the structure was the same as that in Example 1, and the same evaluation was performed for the produced batteries. The result was that the initial ESR value was 24.6 mΩ, the electrolyte reduction rate was 3.3%, and the number of ESR change abnormal batteries was 0.

### (COMPARATIVE EXAMPLE 2)

Comparative Example 2 also relates to a polymer secondary battery. In the basic cell shown in FIG. 1, a conductive film (resistivity: 0.120 Ω·cm) made of an unvulcanized EPDM rubber material having a thickness of 200 μm was used as each collector. The other structure was the same as that in Comparative Example 1, and the same evaluation was performed for the produced batteries. The result was that the initial ESR value was 14.0 mΩ, the electrolyte reduction rate was 65.8%, and the number of ESR change abnormal batteries was 23.

### (COMPARATIVE EXAMPLE 3)

Comparative Example 3 relates to an electric double layer capacitor. In the basic cell shown in FIG. 1, activated carbon was used for the electrodes, and a conductive film (resistivity: 0.390 Ω·cm) made of an unvulcanized IIR rubber material having a thickness of 160 μm was used alone as each collector. The other structure was the same as that in Example 7, and the same evaluation was performed for the produced batteries. The result was that the initial ESR value was 8.2 mΩ, the electrolyte reduction rate was 3.5%, and the number of ESR change abnormal batteries was 0.

In the battery of Example 1, as compared with Comparative Example 1 where the IIR conductive film with the thickness of 200 Ωwas used alone, ESR was significantly lowered while hardly deteriorating the gas barrier performance. Further, as compared with Comparative Example 2 where the EPDM conductive film with the thickness of 200 Ωwas used alone, the gas barrier performance was improved significantly. In the battery of Example 1, by stacking in layers as the rubber materials of the collector, the EPDM rubber material of which the resistivity was low but the gas barrier performance was somewhat low, and the IIR rubber material of which the gas barrier performance was high but the resistivity was somewhat high, the excellent ESR and gas barrier performance were obtained. The ESR abnormality in Comparative Example 2 was induced by an influence of drying up of the electrolyte.

In Example 2, the stacking order of the rubber materials was reversed from that in Example 1. The ESR and gas barrier performance of excellent levels were also obtained in Example 2, but both were somewhat lowered as compared with Example 1. This is considered to be caused by hardness of the rubber materials. With respect to the EPDM rubber material and the IIR rubber material used in Example 2, the hardness of the EPDM rubber material is higher. One surface of the collector is disposed confronting the electrode made of the organic material, while the other surface of the collector is disposed confronting the terminal board made of metal. The metal terminal board is relatively harder than the electrode made of the organic material. In Example 1, the relatively harder EPDM rubber material confronts the electrode relatively less harder than the terminal board, while the relatively less harder IIR rubber material confronts the terminal board relatively harder than the electrode. On the other hand, in Example 2, the relatively harder EPDM rubber material confronts the terminal board relatively harder than the electrode, while the relatively less harder IIR rubber material confronts the electrode relatively less harder than the terminal board. That is, in Example 2, the relatively harder members contact with each other and the relatively less harder members contact with each other, which tends to increase the contact resistance. Accordingly, it is presumed that more excellent ESR was obtained in Example 1 rather than in Example 2. A difference in gas barrier performance is within a range of dispersion, and thus it is considered that there is no essential difference due to the stacking order of the rubber materials.

In Example 3, the conductive film made of the EPDM rubber material whose resistivity was smaller as compared with Example 1 was used. As a result, although ESR was lowered as compared with Example 1, the electrolyte reduction rate was somewhat increased. This is considered to be caused by the fact that the gas barrier performance of the EPDM rubber material was lowered by increasing the ratio of the conductive particles for reducing the resistivity, but there were no batteries that caused ESR change abnormality.

In Example 4, the conductive film made of the unvulcanized EPDM rubber material with the thickness of 50 μm was used as the collector. Like this, even such a film that can not be used alone due to its poor film strength, can be used in the present invention by stacking a plurality of those films to unify them. However, in this example, although ESR was lowered like in Example 3 as compared with Example 1, the electrolyte reduction rate was somewhat increased. This is considered to be caused by the fact that the gas barrier performance of the EPDM conductive film was lowered due to reduction in thickness thereof.

In Example 5, the collector made of the NBR rubber whose resistivity was lower than that of the EPDM rubber used in Example 1 was used. By using the NBR rubber, ESR was lowered as compared with Example 1. The gas barrier performance of the NBR rubber was small, but the reduction of the electrolyte was suppressed by using it along with the IIR rubber.

In Example 6, two EPDM conductive thin films with low resistivity were used and the IIR conductive film was sandwiched therebetween to unify them. The total film thickness was 200 μm that was equal to that in Example 1. However, since the using ratio of the low resistivity collectors was increased, ESR was lowered. On the other hand, since the using ratio of the IIR conductive film was decreased, the electrolyte reduction rate was somewhat increased as compared with Example 1. Even if a film has such a thickness that can not allow the film to be used alone in view of its film strength, stacking a plurality of those films in layers makes it possible to use them.

In Example 7, the collectors of the EPDM conductive film and the IIR conductive film were used in the aqueous electric double layer capacitor that uses activated carbon for the electrodes. The absolute value of ESR of the electric double layer capacitor is generally small. However, by using the low resistive conductive films according to the present invention, ESR was further lowered as compared with Comparative Example 3. Since the using ratio of the IIR conductive film was smaller as compared with Comparative Example 3, the electrolyte reduction rate was somewhat increased.

The reason that ESR of the electric double layer capacitor is smaller than that of the secondary battery is based on a difference in electrode materials. The second battery is normally used as a main power supply, while the electric double layer capacitor is connected to a main power supply and used for absorbing loads so that a voltage drop due to discharge should be made further smaller. In the evaluation for the present invention, non-defective judging criteria were set to no greater than 20 mΩ of the initial ESR and no greater than 10% of the electrolyte reduction rate with respect to the secondary battery, while set to no greater than 7 mΩ of the initial ESR and no greater than 8% of the electrolyte reduction rate with respect to the electric double layer capacitor. The evaluation results with respect to the examples of the present invention and the cited references are collectively shown in TABLE 1.

TABLE 1

| | initial ESR | electrolyte reduction | number of ESR change |
|---|---|---|---|
| | (mΩ) | rate (%) | abnormal batteries |
| Example 1 | 17.5 | 4.2 | 0 |
| Example 2 | 18.5 | 4.2 | 0 |
| Example 3 | 16.1 | 7.2 | 0 |
| Example 4 | 16.9 | 9.0 | 1 |
| Example 5 | 15.5 | 6.8 | 0 |
| Example 6 | 15.0 | 6.5 | 0 |
| Example 7 | 6.5 | 5.5 | 0 |
| Comparative | 24.6 | 3.3 | 0 |
| Example 1 | | | |
| Comparative | 14.0 | 65.8 | 23 |
| Example 2 | | | |
| Comparative | 8.2 | 3.5 | 0 |
| Example 3 | | | |

The present invention is not limited to the polymer secondary battery or the electric double layer capacitor described in the foregoing embodiment, but is also applicable to another energy device having a basic cell structure filled with an electrolyte, such as a lithium secondary battery or a pseudo-capacitor (electrochemical capacitor). Explanation has been made only of the case where two kinds of materials having different compositions are stacked in two or three layers. However, three or more kinds of materials may be used and four or more layers may be stacked, as a matter of course. However, the film thickness increases as the number of stacked layers increases, and thus a two- or three-layered structure is desirable.

What is claimed is:

1. An energy device comprising:
a separator,
a pair of electrodes disposed opposite to each other via said separator;
a pair of collectors disposed so as to be in contact with outer surfaces of said electrodes, respectively;
a gasket cooperated with said collectors to surround said separator and said electrodes; and
an electrolyte filled in a region surrounded by said collectors and said gasket, each of said collectors having a first and a second rubber material stacked in layers.

2. The energy device according to claim 1, wherein said first and said second rubber materials are different in composition from each other.

3. The energy device according to claim 1, wherein said first rubber material has a resistivity smaller than that of said second rubber material.

4. The energy device according to claim 2, wherein said first rubber material has a gas barrier performance smaller than that of said second rubber material.

5. The energy device according to claim 1, wherein said first and said second rubber materials differ in hardness from each other, a smaller one in hardness of said first and said second rubber materials being disposed outside of another of said first and said second rubber materials.

6. The energy device according to claim 1, wherein each of said first and said second rubber materials comprises a base rubber and conductive members compounded in said base rubber.

7. The energy device according to claim 6, wherein the base rubber of said first rubber material is different from the base rubber of said second rubber material in composition.

8. The energy device according to claim 1, wherein each of said first rubber material, said second rubber material, and said gasket has a vulcanization adhesive property.

9. The energy device according to claim 1, wherein each of said collectors has a thickness falling within a range of 120 μm to 200 μm.

10. The energy device according to claim 1, wherein said electrolyte is a metal corrosive electrolyte.

11. The energy device according to claim 1, wherein said electrolyte is an acid electrolyte.

12. A method of fabricating an energy device comprising the steps of:
sandwiching a separator between a pair of electrodes in a stacked manner to form a first assembly;
placing said first assembly within a gasket having a vulcanization adhesive property;
superposing a plurality of rubber materials to each other to form a pair of collectors, each of said rubber materials having each vulcanization adhesive properties;
sandwiching said first assembly between said collectors in a stacked manner to form a second assembly;
pressurizing said second assembly from both sides in a stacking direction thereof; and
heating said second assembly to unify said second assembly.
